(19) United States
(12) Patent Application Publication
(10) Pub. No.: US 2024/0169013 A1
(43) Pub. Date: May 23, 2024

(54) OPTIMIZATION SYSTEM TO SOLVE MULTIVARIATE POLYNOMIAL FUNCTION

(71) Applicant: RIPIK TECHNOLOGY PRIVATE LIMITED, NOIDA (IN)

(72) Inventor: Pinak DATTARAY, Noida (IN)

(73) Assignee: RIPIK TECHNOLOGY PRIVATE LIMITED, NOIDA (IN)

(21) Appl. No.: 17/990,694

(22) Filed: Nov. 20, 2022

(51) Int. Cl. G06F 17/11; G06F 30/27

(52) U.S. Cl. CPC G06F 17/11; G06F 30/27; G06F 2119/18

(57) ABSTRACT

The present invention technically relates to an optimization system that is designed to solve the multivariate polynomial equation based on machine learning. The optimization system comprises a front-end framework to receive a plurality of optimizing queries and a back end to execute the received query. A serve database stores a plurality of data entered on the input interface of the front end and a communication network transmit various recommendation executed by the back-end framework. The optimization system helps to minimize the electricity cost in caustic soda production by executing the optimizing constraints.

### TECHNICAL FIELD OF THE INVENTION

The present invention generally relates to a system and method of optimization. More particularly the present invention relates to approaches for optimizing queries for execution in caustic soda production. Specifically, the invention relates to the optimization of multi-variant polynomial functions that help in reducing the cost of energy in caustic soda production.

### BACKGROUND OF THE INVENTION

Caustic Soda (Sodium Hydroxide or NaOH) is used in several industries including the pulp and paper industry, textile industry, oil and gas industry, soap industry, water treatment, cleaning products, food industry, inorganic industry, and so on. It is typically used as a bleaching agent and oxidizing agent. Electrolysis is a well-known process to produce liquid caustic soda (NaOH) by passing electricity to salt brine (sodium chloride or common salt in water). The process includes extremely high consumption of electricity. It is estimated that the electricity cost in caustic soda manufacturing is almost 80% of the cost of production. Hence, there is a need to solve the problem of electricity consumption cost in caustic soda production.

A prior art by ACS Energy Lett. 2021, 6, 3563-3566 discloses a bipolar membrane electrodialysis (EDBM) and direct electrosynthesis (DE) process to reduce energy costs in caustic soda production. According to the data Chlor-alkali membrane process consumes 2.10-2.15 kWht/kg NaOH of electrical energy and 0.128-0.196 kWht/kg NaOH of thermal energy. Whereas the EDBM process consumes lesser energy in the range of 1.8-3.6 KWht/kg of NaOH. Generally, the potential directions for improving energy efficiency in caustic soda production include optimizing the electrodes, coal mix, product mix, and load distribution on the electrodes. The energy consumption methods discussed in the above-mentioned process are complex and interrelated. Another problem with the above-mentioned method is that these are based on human judgments that are not perfect and optimal. Hence, there is a need for an efficient method of energy optimization in caustic soda production.

A US patent document no. U.S. Ser. No. 10/437,843 discloses an optimization method to optimize database queries via transformation of computational graph. The invention discloses a method that includes performing adaptive learning by running one or more queries having a less than optimal cost and adjusting, by the computing system, or one or more weights corresponding to the weight vector. The respective portions of the optimized computation graph are distributed to one or more of the distributed computing systems for which the respective are optimized for execution.

Another patent application no. US20120047158A1 discloses a method and system for performing query optimization using a hybrid execution plan. The invention provides a hybrid approach to allows different subsets of data accessed by a query to be optimized with different optimizer decisions, execution plans, and/or execution approaches. The present invention can be used to optimize the first Subset of data with a different access path, join order, or join method that is used to optimize the second Subset of data. Transformations may be performed to re-write the query, which restructures the query in a way that facilitates the hybrid optimization process. Multiple transformations may be interleaved to produce an efficient rewritten query.

The power cost in caustic soda production is based on specific power consumption, per unit power cost, coal blend, product mix, electrolyte load, minimum current density (min. CD), maximum current density (Max. CD), and a combination thereof. The reason for limiting other optimization tools like excel, Gurobi, PuLP, Baron, etc. is that these tools cannot handle complex multivariate high-order polynomial functions.

Hence, there is a need for a new optimization tool that can solve multi-variant polynomial functions to optimize electricity cost, production cost, etc. in caustic soda production.

The shortcomings mentioned above, disadvantages, and problems are addressed herein, as detailed below.

### OBJECTIVE OF THE INVENTION

The primary objective of the present invention is to provide an optimization tool that can solve multivariant third-degree polynomial equations.

Another objective of the present invention is to provide an optimization tool that is based on machine learning.

Another objective of the present invention is to provide an optimization tool that can be utilized to optimize electricity costs in caustic soda production.

Another objective of the present invention is to provide an optimization tool that can be utilized to optimize production planning, manpower allocation, and load management on electrolytes.

Another objective of the present invention is to provide a cost-effective optimization tool.

These and other objectives and advantages of the embodiments herein will become readily apparent from the following detailed description in conjunction with the accompanying drawings.

### SUMMARY OF THE INVENTION

Optimizing electricity consumption in caustic soda production is a function of coal management, electrolyte load management, chlorine evacuation, membrane efficiencies, minimum current density (Min. CD), and maximum current density (Max. CD, and a combination thereof. The optimization system is designed to support those processes.

The embodiment of the present invention discloses an optimization system and method of optimization that can solve multi-variant third-degree polynomial equations. The optimization system helps in managing the electrolyte load in the electrolysis process to optimize the electricity cost in caustic soda production. The optimization system of the present invention is based on Machine Learning to reduce the solution scope thereby solving traditionally unsolved optimization problems.

The optimization system can manage cost constraints, such as the constraints that a caustic soda production unit must manage between minimum current density (min CD), maximum current density (max CD), steam heat rate (SHR), coal blend, electrolyte density, power load, storage capacities, chorine evacuation, and a combination thereof. The optimizer system allows planners to set their constraints according to their needs. The tool can be customized based on the product mix, sales requirements, production cost, load management, power load, etc. to lead to a maximum net profit. The optimization system also enables its users to manage the uncertainty inherent to caustic soda production.

According to the present invention, the method of optimizing the electricity constraints in caustic soda production includes, a client/user entering an optimization query in the input form of the front-end interface in the text boxes available on the visual display device of the optimization system. The entered data is then communicated to the cloud database of the optimization system against the corresponding parameter column. The server of the cloud database stores the information in its storage medium. The back end of the optimizing model executes the stored information of the cloud database to provide recommendations for various optimization constraints including electrolyzer load, the current density in the electrolyzer, production of electrolyzer, and, a combination thereof. The recommendation is then transferred to the front end using the communication network of the optimization system. The front-end interface shows all the recommendations on the visual display device of the client.

### BRIEF DESCRIPTION OF THE DRAWINGS

FIG. 1 discloses metrics to show the effect of electrolyte load allocation on power consumption in caustic soda production.

FIG. 2 discloses a view of the input form of the optimization system.

FIG. 3 discloses a view of the output form of the optimization system.

FIG. 4 discloses a view of another output form of the optimization system.

FIG. 5 discloses a view of the product matrix of the optimization tool.

### DETAILED DESCRIPTION OF THE INVENTION

The present invention provides an improved method, system, and computer program product that is suitable for optimization problems in caustic soda production units. An optimization system is utilized in the relational database management system for the purpose to determine the most efficient way to execute a given query by considering different approaches. The present invention discloses an optimization system and method to solve a multivariant high-degree polynomial function to optimize efficient cost management in caustic soda production.

The energy requirement in a different section of the caustic soda production unit includes 22.84 KWh/T NaOH in primary and secondary brine plants, 2754.47 KWh/T NaOH in membrane cell plants, 84.52 KWh/T NaOH in the chlorine treatment plant, 8.69 KWh/T NaOH in caustic concentration unit, 6.24 KWh/T NaOH in caustic evaporation unit, and 5.01 KWh/T NaOH in the wastewater treatment plant. The high energy consumption in the above-mentioned unit is a function of coal mix, product mix, and load distribution on the electrolytes.

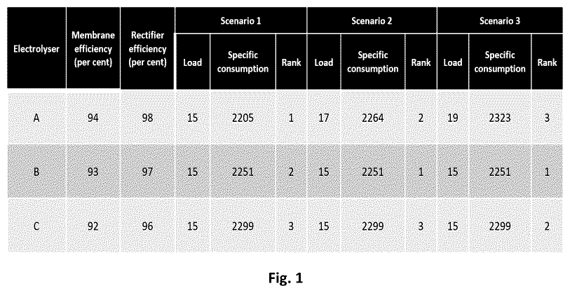

Concerning FIG. 1. it is observed that electrolyte A, B, and C has membrane efficiency of 94, 93, and 92 percent respectively, and Rectifier efficiency of 98, 97, and 96 percent, respectively. The specific energy consumption of the electrolyte is in increasing order of A, B, and C when an equal load is applied to the electrolyte. But when the most efficient electrolyzer run on the highest load, it will become most inefficient. Hence load allocation on the electrolyzer is an important factor to determine power consumption in caustic soda production.

The optimization tool of the present invention is based on Machine Learning and Artificial Intelligence. Machine learning involves using an algorithm to learn and generalize the data based on the previous input and helps to determine accurate and precise results. With the help of Machine learning, it is possible to reduce the solution scope and solve high-degree polynomial functions.

The problem can be described as approximating a function that maps examples of inputs to examples of outputs. Approximating a function can be solved by framing the problem as function optimization. This is where a machine learning algorithm defines a parameterized mapping function (e.g., a production amount of caustic soda as inputs) and an optimization system is used to find the values of the parameters (e.g., coal blend mix, chlorine evacuation, min. CD, max CD, SHR, etc.) that minimize the error of the function when used to map inputs to outputs.

The optimization tool further comprises an optimization engine coded in python language. The other types of coding language that can be used in the present invention include but are not limited to HTML, CSS, Javascript, JQuery, React, and Angular JS. The framework used to develop the front end is ReactJS and the back end is in the framework of Django. The other types of frameworks that can be used to develop frontend and backend include but are not limited to Express, Rails, Laravel, Spring, Angular, HTML, Vue, Ember, and Backbone.

The optimization tool of the present invention can be used to solve problems including but not limited to production planning, manpower allocation, sales output, chlorine evacuation, and a combination thereof.

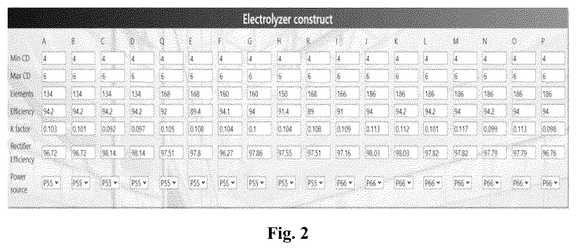

FIG. 2. Shows an exemplary embodiment of the present invention, the load optimization system showing the input form of the present invention. According to the present invention, the column of the input form is showing various electrolyzers from A to P and the rows of the input form are showing various constraints like Min CD, Max CD, Elements, Efficiency, K factor, Rectifier efficiency, and power source that affect electricity consumption in caustic soda production. The values appearing on the input forms can be customized based on the user's requirements. According to another embodiment of the present invention, the client/user can enter their optimization constraints in the input form of the front end of the optimization system or optionally select parameters based on the available database presented on the screen of the input form of the front end.

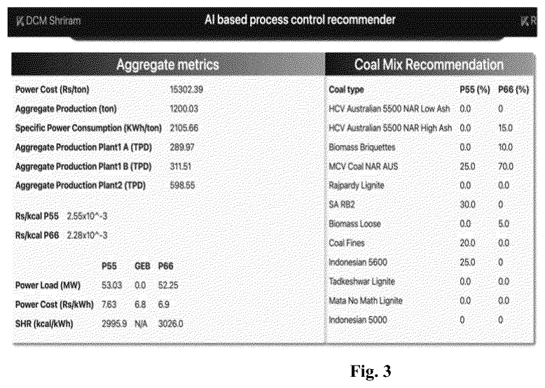

FIG. 3. This shows another exemplary embodiment of the present invention, the optimization engine performs operations that are more advanced than conventional optimizers in several aspects. For example, the architecture of the optimization engine module can be configured to apply advanced machine learning techniques. The scope of the optimization engine can be expanded from a single function query to solving multivariate simultaneous third-degree polynomial equations. The output form of the present invention discloses aggregate metrics of power cost, Aggregate production, Specific power consumption, Power load, min. CD, max. CD, (steam heat rate) SHR, and coal recommendation.

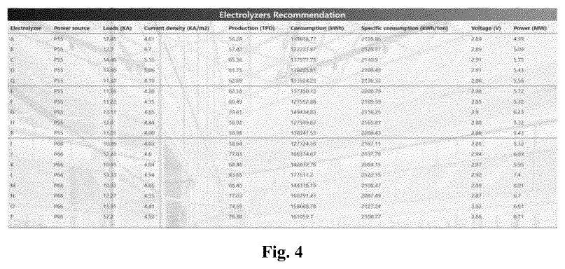

FIG. 4 shows another exemplary embodiment of the output form of the algorithm load optimization tools to determine various electrolyzer loads. According to the present invention, the exemplary load recommendation includes but is not limited to a Power source, Loads (KA), current density (KA/m2), Production (TPD), power consumption (KWh), specific consumption (KWh/ton), and voltage (V).

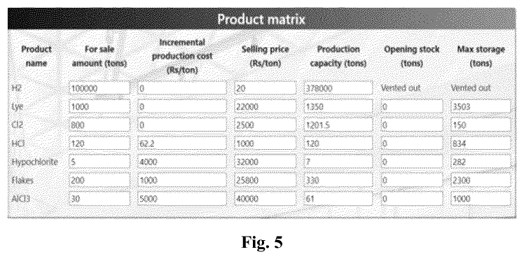

FIG. 5 shows another exemplary embodiment of the present invention. FIG. 5 discloses a view of the product matrix tool that can be utilized to make a key decision is product balancing. The user can enter various factors details for different products to maximize the net profit of the production. The different products include but are not limited to Hydrogen gas (H2), (chlorine gas) Cl2, Hydrogen chloride (HCl), Hypochlorite, Flakes, and AlCl3. The factors that determine net profit include sale amount in tones, increment production costs in tones, selling price (Rs/ton), Production capacity (tons), opening stocks (tons), Maximum storage (tons), and a combination thereof.

According to another embodiment of the present invention, the optimization system of the present invention can be customized based on the number of plants, and plant capacities on both the caustic and power side. The electrolyte's characteristics such as membrane efficiency, K factor, coal mix constraints, chlorine storage, and a combination thereof.

According to another embodiment of the present invention, the optimization tool can be implemented, in part or whole, as software-hardware components, or any combination thereof. In general, the optimization tool can be implemented, in part or, as software running on one or more computing devices or systems, such as on a user computing device or client computing device. The optimization engine system, or at least a portion thereof, can be implemented in the SQL-driven distributed operating system. Further, the optimization engine system or at least a portion thereof can be implemented using one or more computing device or system that includes one or more server, such as network server or cloud servers including Google Cloud performance (GCP), Azure, and AWS.

According to another embodiment of the present invention, the module of the present invention maximizes cost savings by optimizing load balancing on the electrolyzer. For example, when the plant is operating at a lower load, the module helps to reduce specific power consumption. Whereas, when the plant is operating at full loads the module helps to produce more tones of product.

According to another embodiment of the present invention, the method of optimizing the electricity constraints in caustic soda production includes, a client/user entering an optimization query in the input form of the front-end interface in the text boxes available on the visual display device of the optimization system. The entered data is then communicated to the cloud database of the optimization system against the corresponding parameter column. The server of the cloud database stores the information in its storage medium. The back end of the optimizing model executes the stored information of the cloud database to provide recommendations for various optimization constraints including electrolyzer load, the current density in the electrolyzer, production of electrolyzer, and, a combination thereof. The recommendation is then transferred to the front end using the communication network of the optimization system. The front-end interface shows all the recommendations on the visual display device of the client.

We claim:

1. An optimization system for optimizing a query configured by a client/user hosted at an input form, the input form is implementable on a visual display system and the visual display system is coupled to the optimization system, the system comprising:
a) a front-end interface to receive a plurality of optimization constraints at the input form in text boxes of the visual display device;
b) a server database to store the data corresponding to each optimizing constraint;
c) a back-end interface that executes on the stored data to provide various recommendations using an optimizing model; and
d) a communication network that transmits optimized recommendations to the visual display device,
wherein, the optimization system is characterized to solve multivariate third-degree polynomial equations using machine learning.

2. The system as claimed in claim 1, wherein the optimization query is selected from a group of optimization constraints that are required to minimize the electricity consumption in caustic soda production.

3. The system as claimed in claim 1, wherein the user can enter various optimizing constraints at the text box of the front-end interface including but not limited to minimum current density, maximum current density, membrane efficiency, K efficiency, Rectifier efficiency, power source, elements or alike for a plurality of electrolytes.

4. The system as claimed in claim 1, wherein the recommendation optimized by the back-end interface includes aggregate required data of coal mix, power costs, power load, chlorine evacuation, and production cost for different caustic soda plants.

5. The system as claimed in claim 1, wherein the optimization system coding languages can be selected from Python, HTML, CSS, Javascript, JQuery, React, Angular JS, or alike.

6. The system as claimed in claim 1, wherein the front-end and back-end framework can be selected from Django, ReactJS, Express, Rails, Laravel, Spring, Angular, HTML, Vue, Ember, Backbone, or alike.

7. The system as claimed in claim 1, wherein the optimization system or at least a portion thereof can be implemented using one or more computing device or system that includes one or more server, such as network server or cloud servers including Google Cloud performance (GCP), Azure, and AWS.
